(19) United States
(12) Patent Application Publication
(10) Pub. No.: US 2024/0339759 A1
(43) Pub. Date: Oct. 10, 2024

(54) FRAME ASSEMBLY, BASE STATION ANTENNA, AND METHOD FOR ASSEMBLING A BASE STATION ANTENNA

(71) Applicant: CommScope Technologies LLC, Claremont, NC (US)

(72) Inventors: YueMin Li, Suzhou (CN); Junfeng Yu, Suzhou (CN); Changfu Chen, Suzhou (CN); Haifei Qin, Suzhou (CN)

(21) Appl. No.: 18/609,150

(22) Filed: Mar. 19, 2024

(30) Foreign Application Priority Data
Apr. 7, 2023 (CN) 202310369372.0

(51) Int. Cl. H01Q 13/18; H01Q 1/24; H01Q 15/14

(52) U.S. Cl. CPC H01Q 13/18; H01Q 1/246; H01Q 15/14

(57) ABSTRACT

The present disclosure relates to a frame assembly for a base station antenna, comprising: a reflector; a cavity element mounted on a rear end of the reflector, the cavity element comprising a front panel facing the reflector, a first side panel and a second side panel spaced apart from each other extending rearwardly from the front panel, wherein a first cavity for receiving a first phase shift assembly is formed by the front panel, the first side panel and the second side panel, and a channel is provided on the front panel for feeding ends of the first phase shift assembly. In addition, the present disclosure also relates to a base station antenna and method for assembling a base station antenna.

### RELATED APPLICATION

The present application claims priority from and the benefit of Chinese Patent Application No. 202310369372.0, filed Apr. 7, 2023, the disclosure of which is hereby incorporated herein by reference in full.

### TECHNICAL FIELD

The present disclosure relates to communication systems, and more particularly, to a frame assembly for a base station antenna, a base station antenna, and a method for assembling a base station antenna.

### BACKGROUND ART

Cellular communications systems are well known in the art. In a cellular communications system, a geographic area is divided into a series of sections that are referred to as “cells” which are served by respective base stations. The base station may include one or more base station antennas that are configured to provide two-way radio frequency (“RF”) communications with mobile subscribers that are within the cell served by the base station.

In many cases, each base station is divided into “sectors”. In perhaps the most common configuration, a small hexagonally shaped cell is divided into three 120° sectors, and each sector is served by one or more base station antennas that produce a radiation pattern or an “antenna beam” with an azimuth half power beam width (HPBW) of approximately 65°. Typically, the base station antennas are mounted on a tower structure, with the antenna beams that are generated by the base station antennas directed outwardly. Base station antennas are often realized as linear or planar phased arrays of radiating elements.

In order to transmit and receive RF signals to and from a defined coverage area, the antenna beam of the antenna is usually inclined at a certain downward angle with respect to the horizontal plane (referred to as a “downtilt”). In some cases, the antenna may be designed such that the “electrical downtilt” of the antenna may be adjusted from a remote location. With antennas that include such electrical tilt capabilities, the physical orientation of the antenna is fixed, but the effective tilt of the antenna beam may still be adjusted electronically, for example, by controlling a phase shifter that adjusts the phase of signals provided to each radiating element of the antenna. The phase shifter and other related circuits are usually built into the antenna and may be controlled from a remote location. Typically, an AISG control signal is used to control the phase shifter.

Many different types of phase shifters are known in the art, including rotary wiper arm phase shifters, trombone style phase shifters, sliding dielectric phase shifters, and sliding metal phase shifters. The phase shifter is usually constructed together with the power divider as a part of the feeding network (or feeder component) for feeding the phased array. The power divider divides the RF signal input to the feed network into a plurality of sub-components, and the phase shifter applies a variable phase shift to each sub-component individually so that each sub-component is fed to one or a plurality of radiating elements.

### SUMMARY OF THE INVENTION

One of the purpose of the present disclosure is to provide a frame assembly for a base station antenna, a base station antenna, and a method for assembling a base station antenna.

According to a first aspect of the present disclosure, a frame assembly for a base station antenna is provided comprising a reflector; and a cavity element mounted on a rear end of the reflector, the cavity element comprising a front panel facing the reflector, a first side panel and a second side panel spaced apart from each other extending rearwardly from the front panel, wherein a first cavity for receiving a first phase shift assembly is formed by the front panel, the first side panel and the second side panel, and a channel is provided on the front panel for feeding ends of the first phase shift assembly.

According to a second aspect of the present disclosure, a frame assembly for a base station antenna is provided comprising a reflector and a plurality of cavity elements mounted on a rear end of the reflector, wherein each cavity element is secured to the reflector by welding between its front panel and the reflector.

According to a third aspect of the present disclosure, a base station antenna is provided comprising: a frame assembly according to some examples of the present invention; a first array of radiating elements mounted on a front side of a reflector of a frame assembly and at least one first feeding plate for a first array of radiating elements; and a first phase shift assembly mounted within a first cavity of a first cavity element of the frame assembly, a plurality of feeding ends of the first phase shift assembly being electrically connected with a first feeding plate through a front panel of the first cavity element and the reflector.

According to a fourth aspect of the present disclosure, a method for assembling a base station antenna is provided comprising: providing a reflector; securing a plurality of cavity elements to a rear end of the reflector by welding; mounting a radiant element and a feeding plate for the radiant element on a front side of the reflector; receiving a phase shift assembly into a cavity element; moving forward a phase shift assembly housed within the cavity element through an open operating window at a rear end of the cavity element such that a feeding end of the phase shift assembly extends through a channel on a front panel of the cavity element and a weld window on the reflector to a feed plate; and electrically connecting the feeding end of the phase shift assembly with the feeding circuit on the feeding plate by welding.

Other features and advantages of the present disclosure will be made clear by the following detailed description of exemplary examples of the present disclosure with reference to the attached drawings.

### DESCRIPTION OF ATTACHED DRAWINGS

The attached drawings, which form a part of the Specification, describe examples of the present disclosure and, together with the Specification, are used to explain the principles of the present disclosure.

FIG. 1 is an exemplary perspective view of a base station antenna according to some examples of the present disclosure.

FIG. 2 is a schematic end view of the base station antenna in FIG. 1.

FIG. 3 is an exemplary front view of the reflector of the frame assembly according to some examples of the present disclosure.

FIG. 4 is a partially enlarged view of the reflector in FIG. 3, showing a weld window on the reflector.

FIG. 5 is an exemplary perspective view of a cavity element of the frame assembly according to some examples of the present disclosure.

FIG. 6 is an exemplary side view of the cavity element in FIG. 5.

FIG. 7 is a schematic end view of the cavity element in FIG. 5.

FIG. 8 is an enlarged view of a cavity element of a frame assembly according to some examples of the present disclosure.

FIG. 9 is a schematic view of a phase shift assembly to be mounted into the cavity element.

FIG. 10 is a flow chart of a method for assembling a base station antenna according to some examples of the present disclosure.

FIG. 11 is an exemplary perspective view of the cavity element of the frame assembly according to some other examples of the present disclosure.

FIG. 12 is a schematic end view of the cavity element in FIG. 11.

FIG. 13 is a schematic perspective view of the cavity element of the frame assembly according to yet some other examples of the present disclosure.

FIG. 14 is a schematic end view of the cavity element in FIG. 13.

FIG. 15 is a schematic end view of the cavity element of the frame assembly according to yet some other examples of the present disclosure.

It should be noted that in the embodiments described below, the same reference signs are sometimes used across different attached drawings to denote the same parts or parts with similar functions, and repeated descriptions thereof are omitted. In some cases, similar labels and letters are used to denote similar items. Therefore, once an item is defined in one attached drawing, there is no need for further discussion in subsequent attached drawings.

For ease of understanding, the position, dimension, and range of each structure shown in the attached drawings and the like may not indicate the actual position, dimension, and range. Therefore, the present disclosure is not limited to the position, size, range, etc. disclosed in the attached drawings.

### DETAILED DESCRIPTION OF SPECIFIC EMBODIMENTS

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional examples.

It should be understood that the terms used herein are only used to describe specific examples, and are not intended to limit the scope of the present disclosure. All terms used herein (including technical terms and scientific terms) have meanings normally understood by those skilled in the art unless otherwise defined. For the sake of brevity and/or clarity, well-known functions or structures may not be described in detail.

As used herein, when an element is said to be “on” another element, “attached” to another element, “connected” to another element, “coupled” to another element, or “in contact with” another element, etc., the element may be directly positioned on another element, attached to another element, connected to another element, coupled to another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. As used herein, when one feature is arranged “adjacent” to another feature, it may mean that one feature has a portion overlapping with the adjacent feature or a portion positioned above or below the adjacent feature.

In this specification, there may be mentions of elements, nodes, or features that are “coupled” together. Unless otherwise explicitly stated, “coupled” means that one element/node/feature may be mechanically, electrically, logically, or otherwise linked to another element/node/feature in a direct or indirect manner to allow interaction, even if these two features may not be directly connected. In other words, “coupled” is intended to include both direct and indirect connections of elements or other features, including connections via one or more intermediate elements.

As used herein, spatial relational terms such as “above,” “below,” “left,” “right,” “front,” “back,” “high,” “low,” and the like are used to describe the relationship of one feature to another feature in the attached drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the term “exemplary” means “serving as an example, instance, or illustration”, rather than as a “model” to be precisely replicated. Any realization method described exemplarily herein may not be necessarily interpreted as being preferable or advantageous over other realization methods. Furthermore, the present disclosure is not limited by any expressed or implied theory given in the above technical field, background art, summary of the invention or specific embodiments.

As used herein, the word “basically” means including any minor changes caused by design or manufacturing defects, device or component tolerances, environmental influences, and/or other factors. The term “essentially” also allows for the divergence from the perfect or ideal situation due to parasitic effects, noise, and other practical considerations that may be present in the actual implementation.

In addition, for reference purposes only, “first,” “second,” and similar terms may also be used herein, and thus are not intended to be limiting. For example, unless explicitly stated in context, the use of words such as “first,” “second,” or other such numerical terms concerning structures or components does not imply any particular order or sequence.

It should also be understood that when the term “comprising/including” is used herein, it indicates the presence of the specified features, steps, operations, units, and/or components but does not exclude the presence or addition of one or more other features, steps, operations, units, and/or components, and/or combinations thereof.

The present disclosure relates to a frame assembly for a base station antenna, which may comprise a reflector (or reflective plate) and one or a plurality of cavity elements mounted on a rear side of the reflector, wherein a phase shift assembly (or cavity phase shifter) may be mounted in each respective cavity element to achieve feeding to radiating elements mounted on a front side of the reflector. In some examples of the present disclosure, the phase shift assembly may be implemented as a so-called “wireless phase shift assembly”. That is to say, a direct feed connection may be achieved between the phase shift assembly and the feeding plate for the radiant element, thereby eliminating at least the cable connection between the phase shift assembly and the feeding plate, thus reducing cable-related insertion loss, and thereby improving the gain performance of the antenna.

In the present disclosure, the frame assembly for a base station antenna may be formed by fitting various individually constructed cavity elements onto a rear side of the reflector. The reflector of the frame assembly may be formed as an integrally molded reflective plate. In some examples, the reflector may be configured as the only reflector of the base station antenna, at which point the reflector may, for example, essentially define a transverse dimension and a longitudinal dimension of the base station antenna. Each individual cavity element of the frame assembly may similarly be configured as an integrally molded cavity element. Thus, different numbers of cavity elements and/or different arrangements of cavity elements may be arranged flexibly on the reflector depending on the particular application scenario. As such, the frame assembly of the present disclosure may be manufactured in a flexible, efficient, and/or cost-effective manner.

In some examples, the frame assembly for a base station antenna may be formed by welding each individually constructed cavity element, for example, by laser welding, onto the rear side of the reflector. The efficient manufacturing of the frame assembly may thus be further advantageously achieved.

Examples of the present disclosure are now described in more detail with reference to the attached drawings.

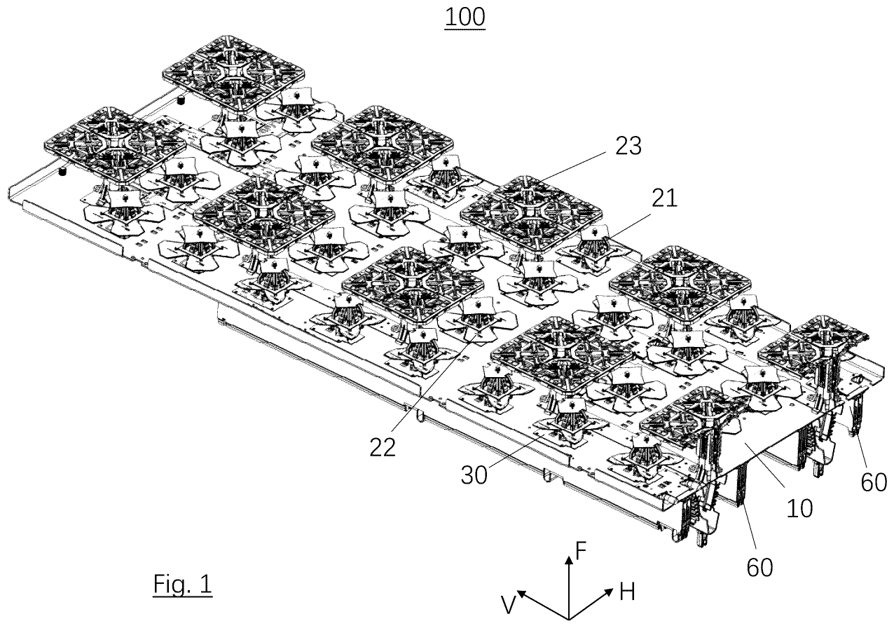

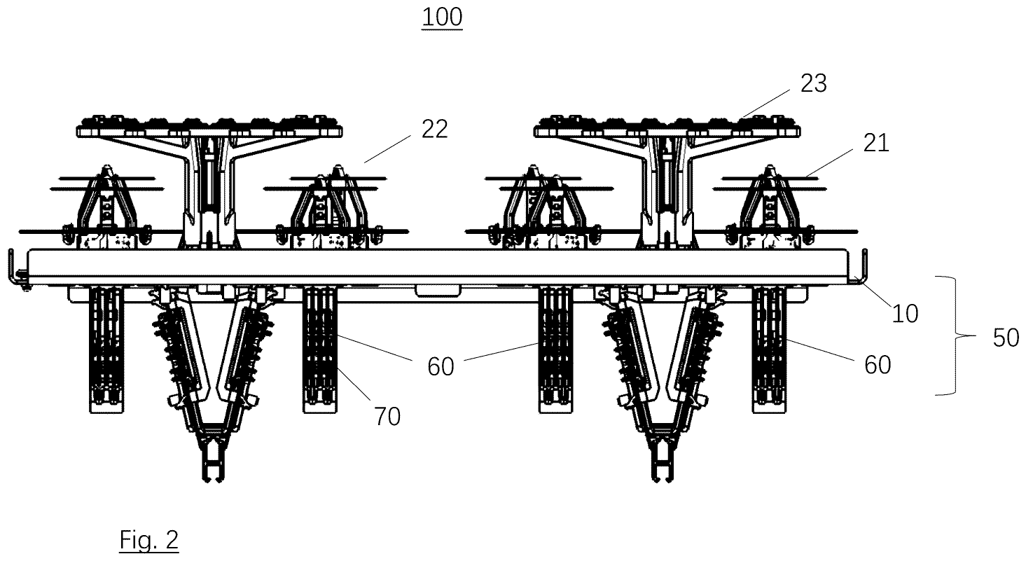

Referring to FIG. 1 and FIG. 2, an exemplary perspective and a schematic end view of a base station antenna 100 according to some examples of the present disclosure are shown respectively.

As shown in FIG. 1 and FIG. 2, the base station antenna 100 comprise an array of first radiating elements 21, an array of second radiating elements 22, and an array of third radiating elements 23, each configured as a linear array. It should be noted that the actual antenna may also comprise other components, and in order to avoid obscuring the main points of the present disclosure, the other components are not shown in the attached drawings and will not be discussed herein.

Each array of first radiating elements 21 may comprise a plurality of first radiating elements 21 arranged in a longitudinal direction V, and configured to operate in a first frequency band. Each array of second radiating elements 22 may include a plurality of second radiating elements 22 arranged in the longitudinal direction V, and configured to operate in a second frequency band. Each array of third radiating elements 23 may include a plurality of third radiating elements 23 arranged in the longitudinal direction V, and configured to operate in a third frequency band. The longitudinal direction V may be the direction of the longitudinal axis of the base station antenna 100 or may be parallel to the longitudinal axis. The longitudinal direction V is perpendicular to a horizontal direction H and a forward direction F. Each radiating element is mounted to extend forwardly (along a forward direction F) from the reflector 10. The reflector 10 may serve as a ground plane structure of each radiating element.

As shown in FIG. 2, the third radiating element 23 may extend forwardly from the reflector 10 further than the first radiating element 21 and the second radiating element 22. In some examples, the first radiating element 21 may, for example, be a mid-band radiating element whose frequency band may be at least a portion of the 1427-2690 MHz frequency band. The second radiating element 22 may, for example, be a mid-band radiating element whose frequency band may be at least a portion of the 1695-2690 MHz or 1427-2690 MHz frequency band. The third radiating element 23 may, for example, be a low-band radiating element whose frequency band may be at least a portion of the 617-960 MHz frequency band. It should be understood that the first radiating element 21 and/or the second radiating element 22 and/or the third radiating element 23 may also be configured as a radiating element that can operate in other frequency bands. This is not limited in the current examples.

Additionally or alternatively, the base station antenna 100 may further comprise a high-band radiating element (not shown) whose frequency band may be at least a portion of the 3500-5000 MHz frequency band.

In other examples, the numbers of low-band, mid-band and/or high-band radiating elements and their linear arrays may be different from the numbers shown in FIGS. 1 and 2. The linear arrays of each radiating element 21, 22, 23 may or may not extend the entire length of the antenna.

Each radiating element 21, 22, 23 may be mounted on a feeding plate printed circuit board 30. The feeding plate printed circuit board 30 is also referred to herein as the “feeding plate 30”. The feeding plate 30 couples RF signals RF signals to and from the individual radiating elements. One or a plurality of radiating elements 21, 22, 23 may be mounted on each feeding plate 30.

The base station antenna 100 may comprise a frame assembly 50 which comprises a reflector 10 and cavity elements 60 mounted on a rear side of the reflector, wherein a phase shift assembly 70 (or cavity phase shifter) may be mounted in each respective cavity element 60 to achieve feeding to radiating elements 21, 22, 23 mounted on a front side of the reflector 10.

In the illustrated example, a plurality of cavity elements 60 are mounted spaced apart from each another on the rear side of the reflector 10 in order to feed corresponding radiating element arrays (exemplified herein as a first array of radiating elements 21 and a second array of radiating elements 22) mounted on the front side of the reflector 10.

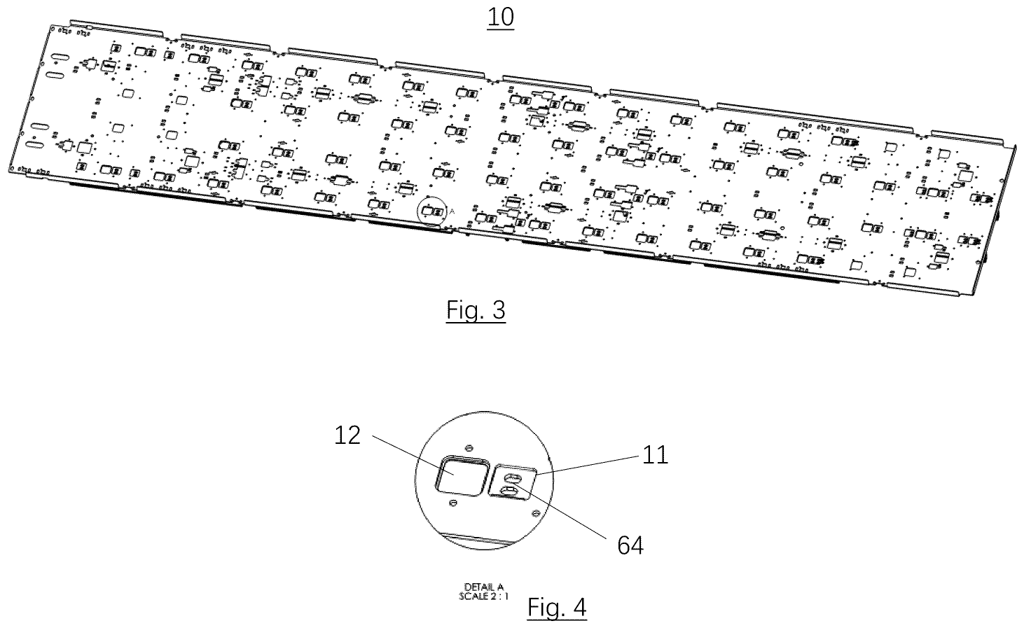

FIG. 3 is an exemplary front view of the reflector 10 of the frame assembly 50 according to some examples of the present disclosure. The reflector 10 of the frame assembly 50 may be configured as an integrally molded reflector plate of a metal (e.g., aluminum) and may be integrally formed by a pultrusion process. This molding process of the reflector 10 is not only efficient but also relatively cost-effective. In some examples, the reflector 10 may be configured as the only reflector 10 of the base station antenna 100, at which point the reflector 10 may, for example, essentially define a transverse dimension and a longitudinal dimension of the base station antenna 100. It should be understood that the reflector 10 may have other variants and is not limited to the current example. In some examples, the reflector 10 may be configured as an essentially flat reflector plate. In some examples, the reflector 10 may be configured as a reflector plate having a localized depression, which may, for example, be used to accommodate the forward dimensions of a low-band radiating element. In some examples, the reflector 10 may be configured as a reflector plate with a choke structure.

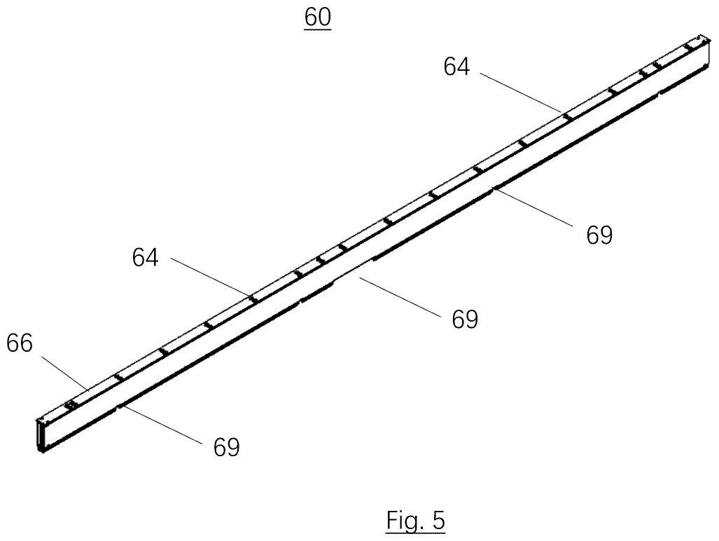

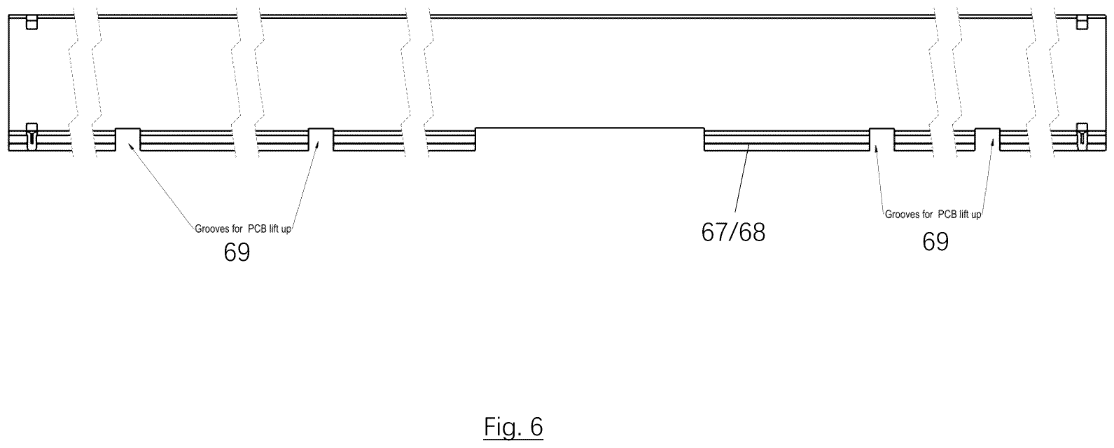

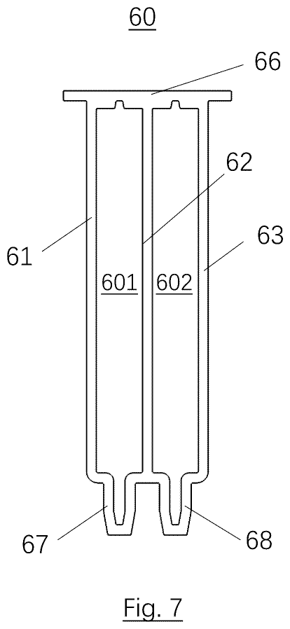

FIG. 5 is an exemplary perspective view of a cavity element 60 of the frame assembly 50 according to some examples of the present disclosure. FIG. 6 is an exemplary side view of the cavity element 60 in FIG. 5. FIG. 7 is a schematic end view of the cavity element 60 in FIG. 5.

The cavity element 60 may be configured as an elongated cavity element. That is to say, the transverse dimension of the cavity element 60 is much smaller than its longitudinal dimension. In some examples, the cavity element 60 may be configured to extend longitudinally over a length of 50%, 60%, 70%, 80% of the reflector 10. In some examples, the cavity element 60 may substantially extend longitudinally the entire length of the reflector 10.

As shown in FIGS. 5 and 7, the cavity element 60 may comprise a front panel 66 facing the reflector 10, along with a first side panel 61, a second side panel 62, and a third side panel 63 spaced apart from each another, each extending rearwardly from the front panel 66. The second side panel 62 may be positioned between the first side panel 61 and the third side panel 63, serving as a common side panel. In some examples, the second side panel 62 may be configured as a flat panel. In some examples, the second side panel 62 may also be configured as a hollow panel structure for reducing weight while improving the rigidity of the cavity element 60. A first cavity 601 for accommodating a first phase shift assembly 70-1 is formed by the front panel 66, the first side panel 61, and the second side panel 62. A second cavity 602 for accommodating a second phase shift assembly 70-2 is formed by the front panel 66, the second side panel 62, and the third side panel 63. Other variants may exist with respect to the composition of the second cavity. In another example not shown, the cavity element may comprise a third side panel and a fourth side panel spaced apart from each another extending rearwardly from the front panel. A second cavity is formed by the front panel, the third side panel, and the fourth side panel for receiving a second phase shift assembly, and a channel is provided on the front panel for a feeding end of the second phase shift assembly to pass through That is to say, the second cavity formed by the front panel, the third side panel, and the fourth side panel may be constructed similar to or essentially the same as the first cavity formed by the front panel, the first side panel, and the second side panel.

In the illustrated example, the cavity element 60 may be configured as a dual-cavity structure, i.e., a first cavity 601 and a second cavity 602, each for accommodating the phase shift assemblies 70, are formed within one cavity element 60, to achieve dual-polarized feeding to dual-polarized radiating elements. It should be understood that, in some examples, the cavity element 60 may also be configured as a single-cavity structure, i.e., only one cavity for accommodating a phase shift assembly 70 is formed within one cavity element 60, to achieve single-polarized feeding. In the case of a single-cavity structure, the cavity element 60 may no longer have a third side panel. In some illustrated examples, the cavity element 60 may be configured as a four-cavity structure, i.e., a first cavity, a second cavity, a third cavity and a fourth cavity, each for accommodating the phase shift assembly 70, are formed within one cavity element 60, to achieve dual-polarized dual-band feeding to dual-polarized dual-band feeding radiating elements. In the case of a four-cavity structure, the cavity element 60 may additionally have a plurality of side panels. In other examples, the cavity element 60 may also be configured as a structure with a different number of cavities, which will not be elaborated here.

Advantageously, the front panel 66 of the cavity element 60 may be configured as an essentially closed and continuous flat panel, which may be attached to the rear side of the reflector 10 in an essentially parallel manner to the reflector 10. That is to say, the front panel 66 of the cavity element 60 is continuous and closed, except for the channel 64 through which the feeding end 340 of the phase shift assembly 70 passes through. Such a substantially closed and continuous front panel 66 not only facilitates improved isolation of the cavity element 60, thereby improving the phase shifting performance of the cavity, but also facilitates a large area of abutment between the cavity element 60 and the reflector 10 (via abutment of a dielectric layer 15, if necessary), thereby enhancing assembly stability between the two.

Advantageously, the first cavity 601 and second cavity 602 of the cavity element 60 may be configured as essentially closed cavities 601, 602. That is to say, the two side panels 61, 62, 63 of each cavity 601, 602 may be connected to each another as a continuous end structure over a large area (60, 70, 80% or more) at the rear end, while remaining closed toward the outside, with only localized open operating windows 69 present. This substantially closed and continuous end structure facilitates further improvement of the isolation of the cavity, thereby improving the phase shifting performance of the cavity.

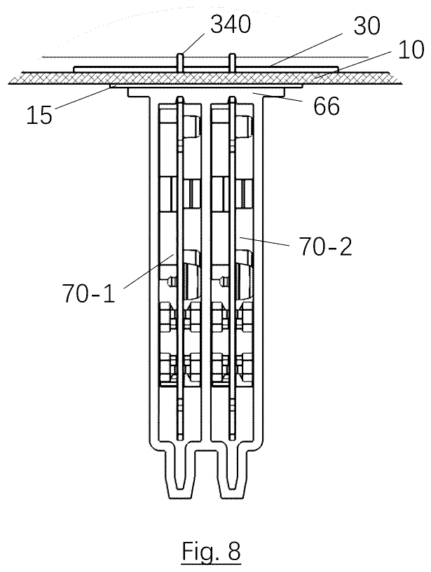

As shown in FIG. 7, each of the two side panels 61, 62, 63 of each cavity 601, 602 comprises a planar plate segment extending rearwardly substantially perpendicular to the front panel 66 and an end segment extending from the planar plate segment towards each other for forming an end structure. In the illustrated example, a first end structure 67 formed by the first side panel 61 and the second side panel 62 may be configured as a transverse narrowing structure with a U-shaped cross-sectional profile. A second end structure 68 formed by the second side panel 62 and the third side panel 63, or the second end structure formed by the third side panel and fourth side panel in a variant described above, may be configured as a transverse narrowing structure with a U-shaped cross-sectional profile. A transverse narrowing structure with a U-shaped cross-sectional profile is advantageous because typically, in the assembled state of the base station antenna 100, the first phase shift assembly 70-1 (as shown in FIG. 8) may not extend into the first end structure 67 and the second phase shift assembly 70-2 (as shown in FIG. 8) may not extend into the second end structure 68. Accordingly, the resonant properties of the cavity may be adjusted by employing a transverse narrowing structure with a U-shaped cross-sectional profile, thereby improving the phase shifting performance of the cavity.

It should be understood that the first end structure 67 and/or the second end structures 68 may have various alternative designs without being limited to the current example, and they will not be elaborated here.

To facilitate operation, such as the moving of the phase shift assembly 70 within the cavities 601, 602, the cavity element 60 may have localized outwardly open operating windows 69 at the rear end (as shown in FIGS. 5 and 6). That is to say, the adjacent side panels 61, 62, 63 may be separated from each other or otherwise spaced apart from each other within an area of the operating windows 69 to allow access into the cavities 601, 602 via the operating windows 69. As shown in FIG. 6, the cavity element 60 may have a plurality of operating windows 69 spaced apart from each other at the rear end to allow access into the cavities 601, 602 via the respective operating windows 69 at a plurality of locations. Advantageously, a force may be applied to move forward the phase shift assembly 70 housed within the cavities 601, 602 through the corresponding operating window 69 such that the feeding end 340 of the phase shift assembly 70 extends through the channel 64 on the front panel 66 of the cavity element 60 and further through the reflector 10 to the feeding plate 30.

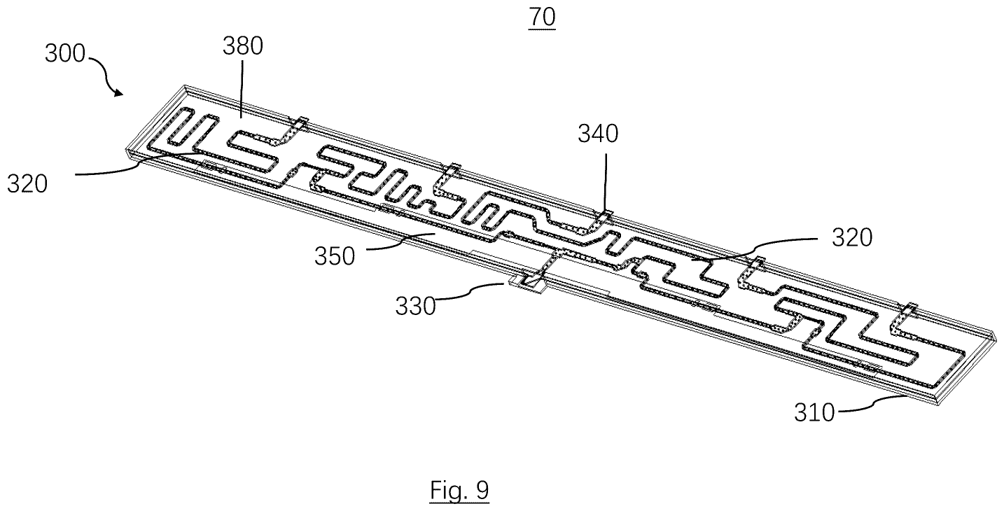

Referring to FIGS. 8 and 9, FIG. 8 is an enlarged view of a cavity element 60 of the frame assembly 50 according to some examples of the present disclosure, and FIG. 9 shows a schematic view of a phase shift assembly 70 to be mounted into the cavity element 60.

As shown in FIG. 9, the phase shift assembly 70 may comprise transmission lines 320 (which function as phase shift lines). The transmission lines 320 are provided with an input end 330 and at least one (e.g., five) output end 340 (i.e., the feeding ends 340 mentioned above). In the current example, the transmission lines 320 may be configured as metal traces printed on a printed circuit board, and the input end 330 and feeding ends 340 may be configured as end sections of these metal traces, such as widened end sections. In other examples, the transmission lines 320 may also be configured, for example, as a metallic inner conductor in a coaxial dielectric phase shifter, and the input end 330 and feeding ends 340 may be configured as end sections of the metallic inner conductor.

Typically, the transmission lines 320 comprise a single input end 330 and a plurality of feeding ends 340. Power dividers are provided along the length of the transmission lines 320 for splitting the RF signal inputs at the input end 320 [sic: 330] into a plurality of sub-components that are output through the respective feeding ends 340.

In addition, the phase shift assembly 70 may also comprise movable elements, such as a movable dielectric element 350 that is movably mounted within the cavity 380. The movable dielectric element 350 may be configured to adjust the relative phase shift of the corresponding sub-components of the RF signals that are output through the corresponding feeding ends 340 of the transmission lines 320. The relative phase shift is adjusted by varying the coverage area or length of the dielectric element 350 over different parts of the transmission lines 320 by utilizing the sliding dielectric phase shifter design as exemplified in the figures. It should be understood that the arrangement of the transmission lines 320 shown in FIG. 9 is only a possible scenario, and their number and arrangement may also be changed as desired.

To allow direct feeding connection between the feeding ends 340 of the phase shift assembly 70 and the feeding plate 30, a plurality of channels 64 are provided on the front panel 66 of the cavity elements 60, through which the respective feeding ends 340 of the phase shift assemblies 70 pass, and a plurality of weld windows 11 with a one-to-one correspondence with the plurality of channels 64 are provided on the reflector 10. As shown in FIG. 5, the channel 64 on the front panel 66 of the cavity element 60 falls into the weld window 11 in a forward direction, thereby allowing the feeding ends 340 of the first phase shift assembly 70-1 to extend through the channel 64 and weld window 11 into the front of the reflector 10.

In some examples, a dielectric layer 15 (as shown in the figure) may be provided between the cavity element 60 and the reflector 10. That is to say, the front panel 66 of the cavity element 60 rests against the rear side of the reflector 10 planarly via the electro-media layer 15. The placement of the dielectric layer 15 may advantageously prevent direct contact over a large area between two separate metal structures, namely the cavity element 60 and the reflector 10, thereby improving the passive intermodulation performance of the base station antenna 100. To allow the feeding ends 340 of the phase shift assembly 70 to pass through, a plurality of windows with a one-to-one correspondence with the plurality of channels 64 may be provided on the dielectric layer 15.

In the example shown in FIG. 8, the feeding ends 340 of the phase shift assembly 70 may extend essentially perpendicular to the reflector 10 through the channels 64 on the front panel 66 of the cavity element 60, the windows on the dielectric layer 15, the weld windows 11 on the reflector 10, and the channels 64 on the feeding plate 30 to electrically connect with the feeding circuit on the front side of the feeding plate 30, such as through welding. It should be understood that the direct feeding connection between the feeding ends 340 of the phase shift assembly 70 and the feeding plate 30 may also occur on the rear side of the feeding plate 30. In other examples, the direct feeding connection between the feeding ends 340 of the phase shift assembly 70 and the feeding plate 30 may also be achieved by means of additional metal conductors, such as probes.

In some examples, the frame assembly 50 for a base station antenna 100 may be formed by welding each individually constructed cavity element 60, for example, by laser welding, onto the rear side of the reflector 10. As shown in FIGS. 1 and 2, each cavity element 60 may be secured to the reflector 10 by welding, such as laser welding, between the front panel 66 thereof and the reflector 10. The efficient manufacturing of the frame assembly 50 may thus be further advantageously achieved. In some examples, each cavity element 60 may be secured to the reflector 10 solely by welding between its front panel 66 and the reflector 10. This further improves the efficient manufacturing of the frame assembly 50. In some examples, each cavity element 60 may also be securely held on the reflector 10 by means of additional fastening structures, such as threaded connection structures and support brackets.

As shown in FIGS. 3 and 4, one or a plurality of weld windows 11 may be provided on the reflector 10 to facilitate welding. The placement of a plurality of weld windows 11 is advantageous in that it increases the welding strength on the one hand; on the other hand, it may improve grounding performance between the reflector 10 and the cavity element 60, thereby further improving the radio frequency performance of the base station antenna 100. The weld window 11 may be configured to allow welding between the front panel 66 of the cavity element 60 and the reflector 10 on the front side of the reflector 10.

On the reflector 10, an evasion window 12 may also be provided, which may be configured to avoid interference from radiating elements or other physical elements mounted in front of the early reflector.

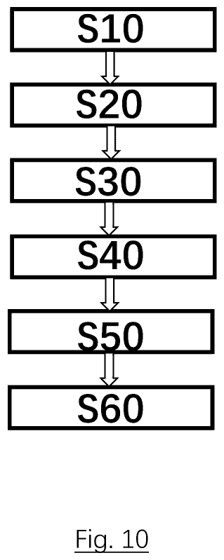

Next, referring to FIG. 10, a method for assembling the base station antenna 100 is exemplarily introduced. It should be understood that the method steps presented below are intended to be illustrative. In some examples, the method may be completed with one or more additional steps not described and/or without one or more of the steps discussed. The order of steps of the methods shown in the figures and described below is not intended to be limiting. In addition, the description above with respect to the base station antenna 100 and the frame assembly 50 may be directly applied to the method herein, and will not be elaborated here. The method for assembling the base station antenna 100 may comprise:
S10: providing a reflector 10;
S20: securing a plurality of cavity elements 60 to the rear side of the reflector 10 by welding, such as laser welding;
S30: mounting radiating elements and a feeding plate 30 for the radiating elements on the front side of the reflector 10;
S40: housing the phase shift assembly 70 within the cavity element 60;
S50: moving forward the phase shift assembly 70 housed within the cavity element 60 through an open operating window 69 at the rear end of the cavity element 60 such that the feeding end 340 of the phase shift assembly 70 extends through a channel 64 on the front panel 66 of the cavity element 60 and the weld window 11 on the reflector 10 to the feeding plate 30;
S60: electrically connecting the feeding ends 340 of the phase shift assembly 70 with the feeding circuit on the feeding plate 30 by welding.

In step S20, laser welding may be implemented along a weld window 11 on the reflector 10, for example, along the edge of the weld window 11, on the front side of the reflector 10.

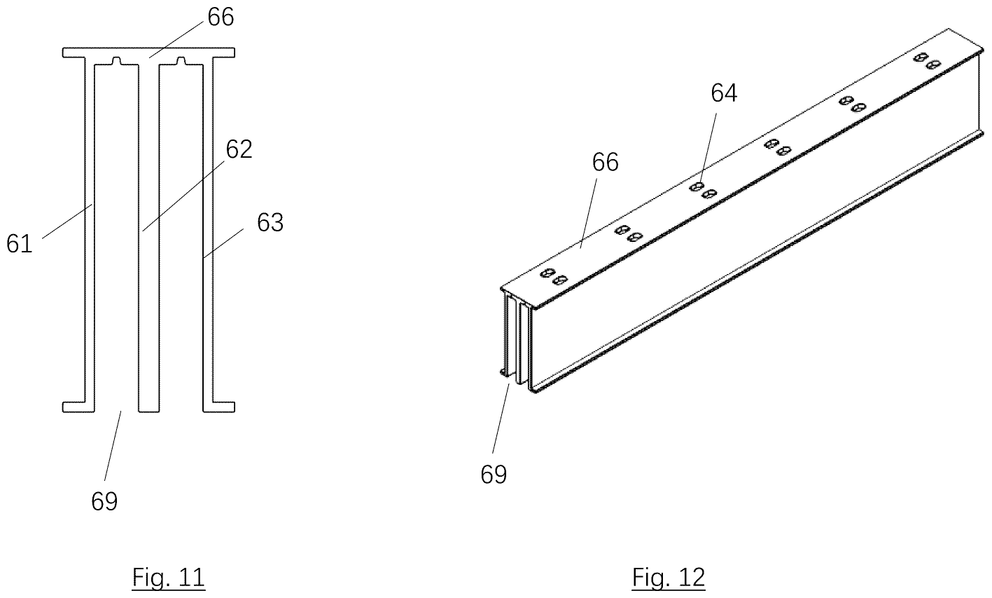

Next, the cavity element 60 of the frame assembly 50 according to some other examples of the present disclosure are described with reference to FIGS. 11 and 12. It should be understood that the main differences from the cavity element 60 presented in the above examples are described herein, and that other relevant elements may be directly applied to the current example.

As shown in FIGS. 11 and 12, the cavity element 60 may comprise a front panel 66 facing the reflector 10, along with a first side panel 61, a second side panel 62, and a third side panel 63 spaced apart from each another, each extending rearwardly from the front panel 66. The second side panel 62 may be positioned between the first side panel 61 and the third side panel 63, serving as a common side panel.

In the illustrated example, the first side panel 61 and the third side panel 63 may each be configured as an L-shaped side panel with a cavity flange for increasing the rigidity of the cavity element 60. The second side panel 62 may be configured as a flat panel.

The front panel 66 of the cavity element 60 may be configured as an essentially closed and continuous flat panel, which may be attached to the rear side of the reflector 10 in an essentially parallel manner to the reflector 10.

The cavity element 60 may be configured as being essentially open at the rear end. That is to say, the two side panels of each cavity may be separated from each other over a large area (60%, 70%, 80%, 90% or more) at the rear end through the operating window 69, while remaining open outward. Such an essentially open end structure facilitates access into the cavity element 60 from the rear end for the operation of the corresponding phase shift assembly 70.

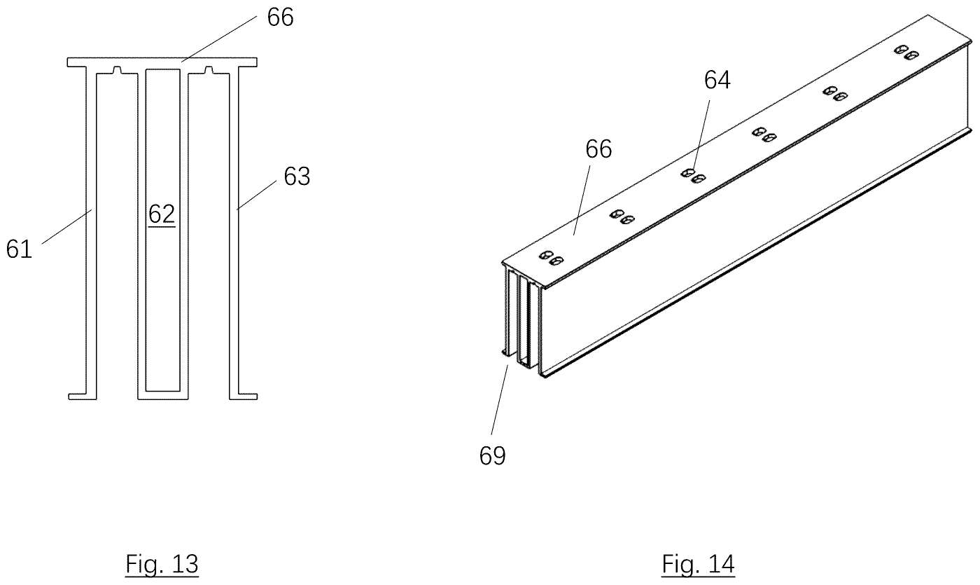

Next, referring to FIGS. 13 and 14, the cavity element 60 of the frame assembly 50 according to yet some other examples of the present disclosure are described. It should be understood that only differences from the cavity element 60 presented in the above examples are described herein, and that other relevant elements may be directly applied to the current example.

As shown in FIGS. 13 and 14, the cavity element 60 may comprise a front panel 66 facing the reflector 10, along with a first side panel 61, a second side panel 62, and a third side panel 63 spaced apart from each another, each extending rearwardly from the front panel 66. The second side panel 62 may be positioned between the first side panel 61 and the third side panel 63, serving as a common side panel.

In the illustrated example, the first side panel 61 and the third side panel 63 may each be configured as an L-shaped side panel with a cavity flange for increasing the rigidity of the cavity element 60. The second side panel 62 may be configured as a hollow panel structure for reducing weight while improving the rigidity of the cavity element 60.

The front panel 66 of the cavity element 60 may be configured as an essentially closed and continuous flat panel, which may be attached to the rear side of the reflector 10 in an essentially parallel manner to the reflector 10.

The cavity element 60 may be configured as being essentially open at the rear end. That is to say, the two side panels of each cavity may be separated from each other over a large area (60%, 70%, 80%, 90% or more) at the rear end through the operating window 69, while remaining open outward. Such an essentially open end structure facilitates access into the cavity element 60 from the rear end for the operation of the corresponding phase shift assembly 70.

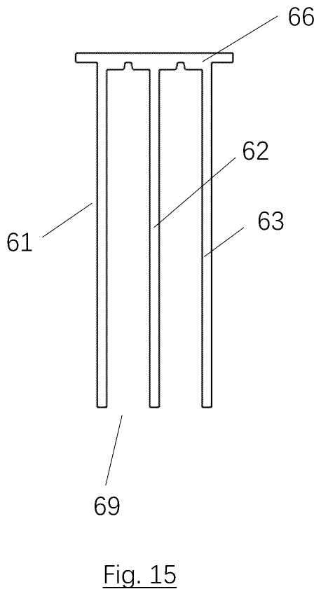

Next, referring to FIG. 15, the cavity element 60 of the frame assembly 50 according to yet some other examples of the present disclosure are described. It should be understood that only differences from the cavity element 60 presented in the above examples are described herein, and that other relevant elements may be directly applied to the current example.

As shown in FIG. 15, the cavity element 60 may comprise a front panel 66 facing the reflector 10, along with a first side panel 61, a second side panel 62, and a third side panel 63 spaced apart from each another, each extending rearwardly from the front panel 66. The second side panel 62 may be positioned between the first side panel 61 and the third side panel 63, serving as a common side panel.

In the illustrated example, the first side panel 61, the second side panel 62, and the third side panel 63 may each be configured as flat panels.

The front panel 66 of the cavity element 60 may be configured as an essentially closed and continuous flat panel, which may be attached to the rear side of the reflector 10 in an essentially parallel manner to the reflector 10.

The cavity element 60 may be configured as being essentially open at the rear end. That is to say, the two side panels of each cavity may be separated from each other over a large area (60%, 70%, 80%, 90% or more) at the rear end through the operating window 69, while remaining open outward. Such an essentially open end structure facilitates access into the cavity element 60 from the rear end for the operation of the corresponding phase shift assembly 70.

Although some specific examples of the present disclosure have been described in detail by examples, those skilled in the art should understand that the above examples are only for illustration, not for limiting the scope of the present disclosure. The examples disclosed herein can be combined arbitrarily without departing from the spirit and scope of the present disclosure. Those skilled in the art should also understand that various modifications can be made to the examples without departing from the scope and spirit of the present disclosure. The scope of the present disclosure is defined by the Claims attached.

1. A frame assembly for a base station antenna, characterized in that the frame assembly comprises:
a reflector;
a cavity element mounted on a rear end of the reflector, the cavity element comprising a front panel facing the reflector, a first side panel and a second side panel spaced apart from each other extending rearwardly from the front panel, wherein a first cavity for receiving a first phase shift assembly is formed by the front panel, the first side panel and the second side panel, and a channel is provided on the front panel for feeding ends of the first phase shift assembly.

2. A frame assembly according to claim 1, characterized in that the cavity element is secured to the reflector by welding between its front panel and the reflector.

3. (canceled)

4. (canceled)

5. A frame assembly according to claim 1, characterized in that the cavity element provides at least partially an operating window at the rear end, and the cavity element can be accessed via the operating window.

6-9. (canceled)

10. A frame assembly according to claim 1, characterized in that the front panel is configured to parallel a planar plate of the reflector.

11. A frame assembly according to claim 1, characterized in that the frame assembly comprises a dielectric layer mounted between the front panel of the cavity element and the reflector.

12. (canceled)

13. A frame assembly according to claim 1, characterized in that the cavity element is configured to be or comprises a dual cavity structure.

14-25. (canceled)

26. A frame assembly according to claim 1, characterized in that the frame assembly comprises a plurality of cavity elements mounted at a distance from one another at a rear end of the reflector.

27. A frame assembly according to claim 1, characterized in that the cavity element is configured as an elongated cavity element.

28-31. (canceled)

32. A frame assembly according to claim 1, characterized in that the cavity element is configured as an integrally molded cavity element.

33. A frame assembly for a base station antenna, characterized in that the frame assembly comprises:
a reflector;
a plurality of cavity elements mounted on a rear end of the reflector,
wherein each cavity element is secured to the reflector by welding between its front panel and the reflector.

34. A frame assembly according to claim 33, characterized in that each cavity element is secured to the reflector by laser welding between its front panel and the reflector.

35. A frame assembly according to claim 33, characterized in that each cavity element is secured to the reflector only by welding between its front panel and the reflector.

36. A frame assembly according to claim 33, characterized in that the plurality of cavity elements are mounted at a rear end of the reflector spaced apart from each other.

37. (canceled)

33. A frame assembly according to claim 33, characterized in that each cavity element comprises a front panel facing the reflector, a first side panel and a second side panel spaced apart from each other extending rearwardly from the front panel, respectively, wherein a first cavity is formed by the front panel, the first side panel, and the second side panel for receiving a first phase shift assembly.

39. (canceled)

40. A frame assembly according to claim 33, characterized in that each cavity element provides at least partially an operating window at the rear end, and the cavity element can be accessed via the operating window.

41. A base station antenna, comprising:
a frame assembly according to claim 1;
a first array of radiating elements mounted on a front side of the reflector of the frame assembly and at least one first feeding plate for the first array of radiating elements; and
a first phase shift assembly mounted within the first cavity of a first the cavity element of the frame assembly, a plurality of feeding ends of the first phase shift assembly being electrically connected with the first feeding plate through a front panel of the first cavity element and the reflector.

42. A base station antenna according to claim 41, characterized in that a second phase shift assembly mounted within a second cavity of the cavity element of the frame assembly, a plurality of feeding ends of the second phase shift assembly being electrically connected with the first feeding plate through a front panel of the cavity element and the reflector.

43-45. (canceled)

46. A method for assembling a base station antenna, the method comprising: providing a reflector;
securing a plurality of cavity elements to a rear end of the reflector by welding;
mounting a radiant element and a feeding plate for the radiant element on a front side of the reflector;
receiving a phase shift assembly into a cavity element;
moving forward a phase shift assembly housed within the cavity element through an open operating window at a rear end of the cavity element such that a feeding end of the phase shift assembly extends through a channel on a front panel of the cavity element and a weld window on the reflector to a feed plate; and
electrically connecting the feeding end of the phase shift assembly with the feeding circuit on the feeding plate by welding.

47. A method according to claim 46, characterized in that each cavity element is secured to the reflector by laser welding between its front panel and the reflector.

48. (canceled)
